(19) United States
(12) Patent Application Publication
(10) Pub. No.: US 2007/0069536 A1
(43) Pub. Date: Mar. 29, 2007

(54) Load supporting apparatus with integrated coupling for lifting

(76) Inventor: Victor Joseph Segura, New Iberia, LA (US)

Correspondence Address: Ted M. Anthony;Suite 1600, 600 Jefferson Street, Lafayette, LA, 70501, US

(21) Appl. No.: 11/600,690

(22) Filed: Nov. 16, 2006

Related U.S. Application Data
(63) Continuation of application No. 10/388,781, filed on Mar. 14, 2003, now abandoned.
Application No. 10/388,781 is a continuation-in-part of application No. 09/814,553, filed on Mar. 22, 2001, now abandoned.

(51) Int. Cl. A47J 45/00

(52) U.S. Cl. 294/1.1

(57) ABSTRACT

An integrated lifting apparatus for attaching to a sling has a generally horizontal base and at least one upright post extending from the base. Each post is generally hollow and has a cut-away upper surface, as well as a vertical slot near such upper surface. A horizontal bore extends through each post near its upper end. A threaded bolt having an enlarged head on one end, preferably constructed of high strength and/or shear resistant material, is inserted through each bore and the loop of a sling. A lock nut is threaded onto the end of the bolt to secure the bolt in place.

### CROSS REFERENCES TO RELATED APPLICATIONS

This is a continuation of application Ser. No. 10/388,781 filed Mar. 14, 2003, currently pending, which is a continuation-in-part of application Ser. No. 09/814,553, filed Mar. 22, 2001, now abandoned.

### STATEMENTS AS TO RIGHTS TO INVENTIONS MADE UNDER FEDERALLY SPONSORED RESEARCH AND DEVELOPMENT

None

### BACKGROUND OF THE INVENTION

1. Field of the Invention

The present invention relates to a lifting apparatus which can be used in connection with a crane or hoist for the loading or unloading of cargo. More specifically, the present invention relates to a lifting apparatus which improves the strength characteristics of pallets, baskets and other structures used for containing or supporting loads being lifted, while eliminating the need for welded pad-eyes, loops or similar devices on such pallets, baskets or other structures.

2. Description of the Related Art

Numerous devices have been devised for the purpose of lifting baskets, large production skids or similar equipment so that they may be transported from one location, such as on board a boat, to another location, such as an offshore platform, using a crane, hoist or other lifting means. In the course of such transport activities, consideration must be given to maintaining of control of such load during the lifting process, as well as to other primary considerations such as ease in making connections and disconnections, and the protection or preservation of the equipment being transported. Perhaps more significantly, consideration must also be given to the minimizing of possible failure locations on the item(s) being lifted, as well as the related lift equipment.

In carrying out lifting operations of this type, large or heavy loads are typically lifted using a set of slings connected to the line of a crane or hoist. Although it is often possible to connect a crane or hoist line directly to a load to be lifted using shackles or the like, slings generally provide an intermediate means to quickly and efficiently connect such line to a load. Further, because many slings utilize two or more separate lines connected to a central link or loop, slings generally allow for more even weight distribution during the lifting process. When such slings are used, one end of each of the various sling lines is attached to the particular load to be lifted, while the other end of said sling lines is attached to a central link or loop. The central link or loop of the slings is in turn connected to the lifting line of a crane or hoist.

This method of using slings to lift and/or transport equipment, cargo or other loads is very common in offshore or marine operations, as well as numerous other applications, such as the loading and unloading of ships and other vessels at loading docks. It should be noted that the offshore oil and gas industry, although representative of the issues faced in the lifting and transportation of heavy loads, is but one application involving such issues.

Generally, when slings are used for lifting large or heavy loads, the individual lines of such slings are attached to pad-eyes affixed to the load in question. For example, large baskets used to transport cargo to or from an offshore platform may have one or more pad-eyes affixed to the exterior of such baskets. In many instances, shackles or other joining means can be used to connect the individual lines of the slings to such pad-eyes.

Such pad-eyes are frequently welded to the loads being lifted. In many cases, welded pad-eyes can exhibit satisfactory strength characteristics. However, if such welds are required to support heavy loads on multiple lifts, over time such welds can become subject to fatigue and stress forces. Obviously, when loads are being lifted over a large distance, such as from a boat to an offshore oil and gas platform, a broken weld on a pad-eye could have disastrous consequences. A load dropped from a high elevation could severely damage property, or worse, injure or kill personnel in the area.

In the offshore oil and gas industry, as well as numerous other industries wherein heavy loads are routinely lifted, safety is a paramount concern. In order to reduce or eliminate failure of welded pad-eyes, many operators have instituted scheduled and/or periodic inspection of welded pad-eyes. In some cases, operators utilize x-ray inspection to detect cracks or other signs of weakness in pad-eye welds. Of course, if a particular weld fails inspection, the equipment in question should be repaired or completely removed from service. In some cases, operators may replace pad-eyes, or entirely remove certain equipment from service, based entirely on the number of lifts that have been performed using such pad-eyes.

Hence, the invention described herein provides an integrated lifting apparatus having strength characteristics which meet or exceed those of welded pad-eyes, while eliminating the need for welded pad-eyes and/or other parts. By eliminating the need for welded parts, users can avoid the requirement of expensive inspection programs, as well as the costs associated with taking equipment out of service on a temporary or permanent basis. Further, the invention described herein provides an integrated lifting apparatus which can be quickly and easily connected to, or disconnected from, a set of slings or other means used in the lifting process.

### SUMMARY OF THE INVENTION

The present invention discloses an integrated lifting apparatus which eliminates the problems associated with welded pad-eyes. The present invention can be integrally attached to the item to be lifted, such as on a basket or the like. Alternatively, the present invention can be integrally attached to a skid, pallet or other platform upon which otherwise free-standing equipment or cargo can be loaded.

In the preferred embodiment, each integrated lifting apparatus of the present invention comprises a substantially hollow post or member. A lateral bore is provided near the upper end of such substantially hollow post and extends through said hollow post. A threaded pin or bolt having an enlarged head on one end, preferably constructed of high strength and/or shear resistant material, is disposed through said lateral bore. In the preferred embodiment, said bolt is at least partially threaded. A lock nut, having an outer diameter greater than the diameter of said bore, is threaded onto the end of said bolt. If desired, a cotter pin can also be used to secure such lock nut on said bolt.

The individual lines of a set of slings (or the line of a crane or hoist itself) can be easily attached to a load to be lifted using the lifting apparatus of the present invention. The procedure for attaching such slings, or other lines is as follows. If a cotter pin is used, it is first removed. Thereafter, the lock nut is unscrewed from the high strength bolt, and the bolt is removed from the bore in said substantially hollow post. A sling loop, or shackle connected to such a loop, is then placed between the walls of the hollow post, and the high strength bolt is re-inserted through said bore, as well as said sling loop or shackle. The lock nut is then threaded back on to the high strength bolt. If desired, the cotter pin is then installed to help ensure that the lock nut remains in place. When multiple-line slings are used, each line of said slings can be attached to the load in question using two or more of the lifting apparatuses of the present invention. As is readily apparent, the process is simply reversed in order to remove such sling from the lifting apparatus of the present invention.

In certain applications, it may be desirable to allow a set of slings, attached to a piece of equipment or other load using the integrated lifting apparatus of the present invention in the manner set forth above, to remain attached to said piece of equipment or other load. By doing so, a user needs only to attach the line from a crane or hoist directly to the central link of such slips in order to attach to and lift the load in question. This greatly reduces the amount of time and effort required to attach individual sling lines to a load to be lifted, as well as the time and effort required to unhook same. Further, when a particular set of slings has been used for a predetermined number of lifts, such slings can be quickly and easily removed, replaced and discarded or refurbished, as desired.

### BRIEF DESCRIPTION OF THE DRAWINGS

FIG. 1 is a diagrammatic view depicting equipment being loaded from an offshore platform on to a boat using a crane.

FIG. 2 is a side view of a basket equipped with the lifting apparatus of the present invention.

FIG. 3 is an overhead view of the integrated lifting apparatus of the present invention.

FIG. 4 is a side view of the integrated lifting apparatus of the present invention without a bolt in place.

FIG. 5 is a side view of the integrated lifting apparatus of the present invention, shown with one line of a sling attached thereto.

FIG. 6 is a side cut away view of the integrated lifting apparatus of the present invention.

FIG. 7 is a side perspective view of the integrated lifting apparatus of the present invention.

FIG. 8 is a side cut away view of the integrated lifting apparatus of the present invention without a bolt in place.

### DESCRIPTION OF THE PREFERRED EMBODIMENT(S)

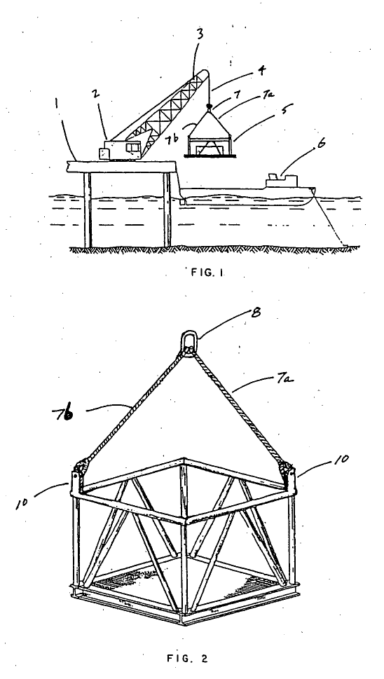

Referring to the drawings, FIG. 1 depicts a diagrammatic view of a piece of equipment, in this case a cargo basket, being loaded from an offshore platform to a waiting boat, using a crane. Platform 1 provides a foundation for crane 2, having boom 3 and line 4. Basket 5 is shown being lowered onto waiting boat 6 using crane 2. Slings 7 are used to connect line 4 of crane 2 to basket 5. Slings 7 utilize multiple lines 7a and 7b, to evenly distribute the weight of basket 5, and provide stability during the lift and transfer of basket 5 from platform 1 to boat 6.

It is well known in the prior art to utilize pad-eyes, welded or otherwise attached to a load such as basket 5, in order to provide connection means for attaching lines 7a and 7b of sling 7 to basket 5. The integrated lifting means of the present invention eliminates the need for such pad-eyes, and the numerous problems and safety concerns associated with such pad-eyes and/or similar devices.

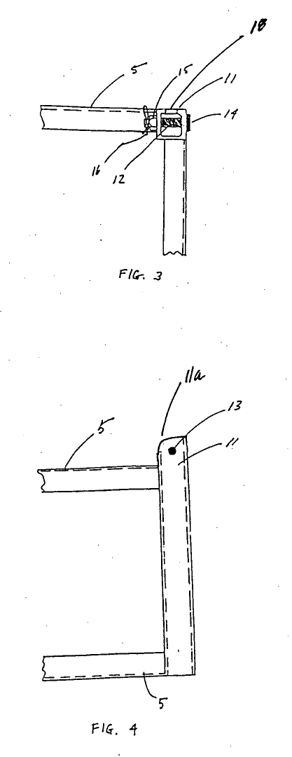

FIG. 2 depicts a detailed view of basket 5 equipped with the integrated lifting apparatus 10 of the present invention. In order to improve stability of the load during a lift, basket 5 is equipped with two such lifting apparatuses at opposing corners of basket 5. For illustration purposes, basket 5 is shown with only two sling lines attached to said basket 5. However, many different numbers and configurations of sling lines can be employed to connect to basket 5, or other similar loads. For example, it may be preferable for stability purposes to have a separate sling line connected to an integrated lifting apparatus on each of the four corners of basket 5. Lower ends of lines 7a and 7b of slings 7 are each attached to an integrated lifting apparatus 10, while the upper ends of lines 7a and 7b are each connected to central loop 8 of slings 7. When using a crane or hoist to lift basket 5, the lifting line of such crane or hoist (such as line 4 of FIG. 1, for example) can be attached to central loop 8 of slings 7 using a hook or other connection means.

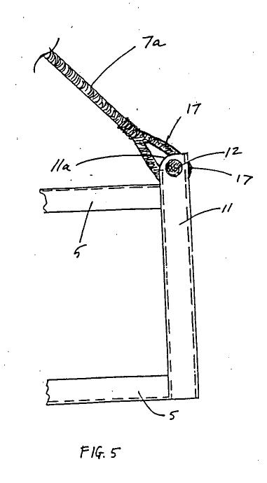

FIG. 3 depicts an overhead view of integrated lifting apparatus 10 of the present invention. In the preferred version of this embodiment, substantially hollow vertical post 11 forms a four-sided corner post of basket 5. It should be noted that there is generally no requirement that substantially hollow vertical post 11 necessarily be comprised of four sides. Said substantially hollow post could exhibit a wide variety of different sides or cross-sectional shapes. For example, it is possible that said substantially hollow post could be generally cylindrical in shape, thereby exhibiting a substantially circular cross sectional configuration. Further, said substantially hollow vertical post can be oriented in any number of different dimensions or positions relative to the load being lifted in order to provide desired operational flexibility.

Still referring to FIG. 3, bolt 12 is inserted within bore 13 (not shown in this view) extending horizontally through hollow vertical post 11. Bolt 12 has enlarged head 14, having a diameter larger than bore 13 which extends through said hollow vertical post 11. The end of bolt 12 which is opposite head 14, has threads. Lock nut 15 is threaded on to the threads of bolt 12. In the preferred embodiment, cofter pin 16 is inserted through a bore in bolt 12 in order to ensure that lock nut 15 remains threaded on bolt 12. Elongate aperture 18 is formed along the outer wall of said substantially hollow vertical post 11.

FIG. 4 depicts a side view of integrated lifting apparatus 10 of the present invention. In the preferred version of this embodiment, substantially hollow vertical post 11 forms an integral vertical corner member of basket 5. However, it should be noted that substantially hollow post 11 can be attached to, or incorporated in, the load to be lifted in any number of different ways. By way of example, but not limitation, substantially hollow vertical post 11 could comprise a structural member of a pallet or other lifting device. Bore 13 extends horizontally through substantially hollow post 11. In the preferred embodiment, upper surface 11a and a portion of the inner wall of substantially hollow post 11 are rounded off to form a substantially convex surface in order to provide greater access to bolt 12.

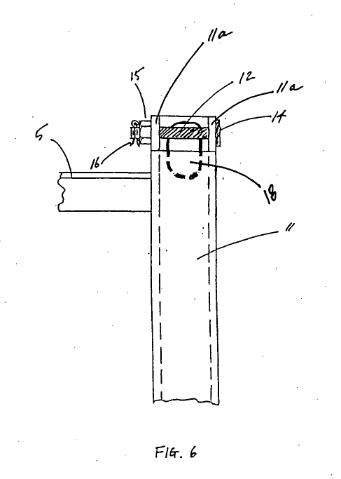

FIG. 5 depicts a side view of the integrated lifting apparatus 10 of the present invention with one line of a multiple-line sling attached thereto. Substantially hollow vertical post 11 forms a vertical corner post of basket 5. Bolt 12 is inserted within horizontal bore 13 (not shown in this view), and passes through loop 17 of sling line 7a. Although bolt 12 is shown passing through loop 17 of sling line 7a for purposes of this illustration, it should be recognized that shackles and/or other similar devices or means could be used to connect said sling line 7a to integrated lifting apparatus 10 of the present invention. In the preferred embodiment, upper edge 11a and a portion of one side of substantially hollow vertical post 11 is cut away or rounded off in order to provide a convex shape along the upper surface thereof, thereby improving the strength characteristics of hollow vertical post 11 during lifting operations.

Still referring to FIG. 5, a portion of sling loop 17 is depicted protruding through elongate aperture 18 on the outer wall of substantially hollow vertical post 11. Said elongate aperture 18 can accommodate said sling loop 17 to provide greater freedom of movement for said sling loop 17, which is frequently required to move relative to, or rotate about, fixed bolt 12. Without said elongate aperture 18, part of sling loop 17 (or other connection means such as, for example, a shackle or other similar device) could get wedged between bolt 12 and the outer wall of substantially hollow vertical post 12, thereby resulting in a reduced range of movement. Under certain circumstances, such pinching or wedging of a portion of sling loop 17 in the manner described above could potentially cause a catastrophic failure resulting in disconnection of sling line 7a from integrated lifting apparatus 10. Even if catastrophic failure does not occur, such pinching or wedging can negatively impact strength characteristics.

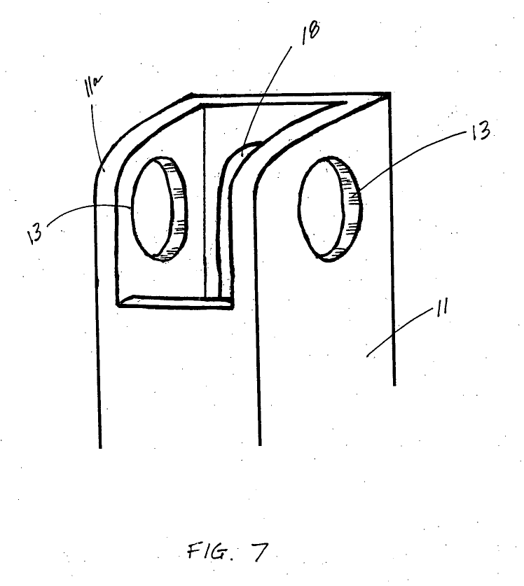

FIG. 6 depicts a side cut away view of the integrated lifting apparatus 10 of the present invention. Substantially hollow vertical post 11 forms a structural corner member of basket 5. Bolt 12 is inserted within a bore 13 extending horizontally through hollow vertical post 11. Bolt 12 has enlarged head 14, having a diameter larger than said bore 13 which extends through said substantially hollow vertical post 11. The end of bolt 12 which is opposite head 14, has threads. Lock nut 15 is threaded on to the threads of bolt 12. Cotter pin 16 is inserted through a bore extending through bolt 12 in order to ensure that lock nut 15 remains in place on bolt 12. Upper surface 11a, and a portion of one wall of substantially hollow vertical post 11, is rounded off or otherwise cut away, thereby resulting in the removal of a portion of said hollow vertical post 11 in the general area of bolt 12. Such rounding of upper surface 11a generally permits greater access to bolt 12, as well as freedom of movement for a shackle or sling loop which may be attached to bolt 12.

Elongate aperture 18 is depicted along one wall of said substantially hollow vertical post 11. In the preferred embodiment, said elongate aperture 18 is positioned on the outer wall of substantially hollow vertical post 11, said wall being the only fully extending (i.e. not partially removed) wall of said post 11.

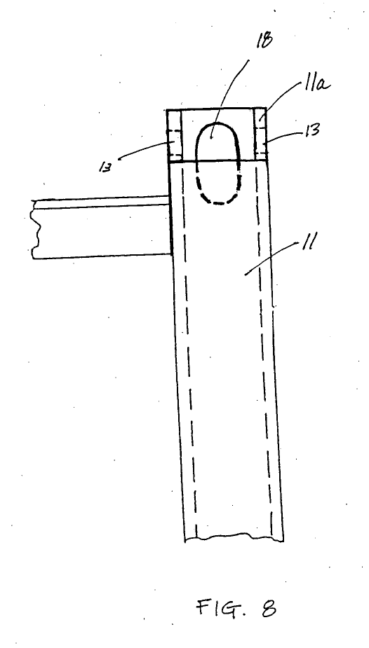

FIG. 7 depicts a side perspective view of the integrated lifting apparatus 10 of the present invention, without bolt 12 disposed through horizontal bore 13. Substantially hollow vertical post 11 is depicted as a four-sided member, having a generally square cross-sectional configuration. Horizontal bore 13 extends through two opposing walls of said substantially hollow vertical post 11. Said horizontal bore 13 provides an aperture for bolt 12, not depicted in FIG. 7, which can be received within said horizontal bore 13.

Upper surface 11a, and a portion of one wall of substantially hollow vertical post 11, are cut away. In the preferred embodiment, upper surface 11a of substantially hollow vertical post 11 is rounded off, exhibiting a generally convex shape. Elongate aperture 18, partially obscured from view in FIG. 7, is located on the wall of substantially hollow vertical post which is opposite the partially cut away wall of said substantially hollow vertical post 11. In the preferred embodiment, aperture 18 is generally elongate in shape. Elongate aperture 18 provides an opening for receiving a portion of sling loop 17. Put another way, because elongate aperture 18 provides an opening for receiving a portion of sling loop 17, said sling loop will not be pinched or otherwise caught between bolt 12 and the outer wall of substantially hollow vertical post 11. In addition to providing an aperture for receiving a portion of sling loop 17, or some other connection means, elongate aperture 18 improves the overall strength characteristics of substantially hollow vertical post 11. For example, if the upper portion of the outer wall of said vertical post 11 was removed entirely, said vertical post would exhibit greatly diminished strength characteristics.

FIG. 8 is a side cut-away view of the integrated lifting apparatus of the present invention, shown without bolt 12 received within bore 13. Upper surface 11a, and a portion of the front side of substantially hollow vertical post 11, is rounded off or otherwise cut away, thereby resulting in the removal of a portion of said hollow vertical post 11 in the general area of bolt 12. Such rounding of upper surface 11a generally permits greater access to bolt 12, as well as freedom of movement for a shackle or sling loop which may be attached to bolt 12.

In the preferred embodiment, a line of a set of slings, such as line 7a of slings 7, can be easily attached to the lifting apparatus of the present invention. Referring to FIG. 6, cotter pin 16 is first removed from the bore extending through bolt 12. Thereafter, lock nut 15 is unscrewed from bolt 12, and said bolt 12 is removed from bore 13 in substantially hollow vertical post 11. A sling loop (or shackle) is then placed between the walls of substantially hollow vertical post 11 so that the opening formed by said loop is in general alignment with bore 13. Bolt 12 is then re-inserted through the bore in one wall of substantially hollow vertical post 11, the opening of said sling loop, and the corresponding bore in the opposing wall of substantially hollow vertical post 11. Lock nut 15 is then re-threaded back on to the threaded end of bolt 12. If desired, cotter pin 16 can then be installed to help ensure that lock nut 15 remains in place. As is readily apparent, the process is simply reversed in order to remove such sling from the lifting apparatus of the present invention.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed is:

1. A load supporting apparatus for transporting materials comprising:
a. a substantially horizontal base;
b. at least one substantially hollow upright member, said at least one substantially hollow upright member having a length, a first end, and a second end, said first end of said at least one substantially hollow upright member affixed to said substantially horizontal base with said at least one substantially hollow upright member extending substantially perpendicular to said horizontal base, said second end of said at least one substantially hollow upright member being cut at an angle to the longitudinal axis of said at least one substantially hollow upright member, thereby defining a long side and a short side of said at least one substantially hollow upright member;
c. an elongate aperture in said long side of said substantially hollow upright member, wherein said elongate aperture is oriented substantially perpendicular to said substantially horizontal base;
d. a first hole extending through said at least one substantially hollow upright member between the long side and the short side of said at least one substantially hollow upright member;
e. a second hole extending through said at least one substantially hollow upright member between the long side and the short side of said at least one substantially hollow upright member, wherein said first and second holes are aligned;
f. a rigid member disposed through said first and second holes; and
g. means for securing said rigid member within said first and second holes.

2. The load supporting apparatus of claim 1, wherein said rigid member is a bolt having threads.

3. The load supporting apparatus of claim 2, wherein said means for securing said rigid member comprises a nut screwed on the threads of said bolt.

4. A load supporting apparatus for transporting materials comprising:
a. a substantially horizontal base having a center;
b. a plurality of substantially hollow upright members, each having a length, a first end, and a second end, wherein the first end of each substantially hollow upright member is affixed to said substantially horizontal base, each substantially hollow upright member extends substantially perpendicular to said horizontal base, and the second end of each substantially hollow upright member is cut at an angle to the longitudinal axis of said substantially hollow upright member, thereby defining a long side and a short side, and wherein the short side of each substantially hollow upright member is oriented toward the center of said base;
c. an elongate aperture in the long side of each substantially hollow upright member, wherein each elongate aperture is substantially perpendicular to said substantially horizontal base;
d. a first hole extending through each substantially hollow upright member between the long side and the short side of said substantially hollow upright member;
e. a second hole extending through each substantially hollow upright member between the long side and the short side of said substantially hollow upright member, wherein said first and second holes are aligned;
f. a rigid member disposed through said first and second holes; and
g. means for securing said rigid member within said first and second holes.

5. The load supporting apparatus of claim 4, wherein said rigid member is a bolt having threads.

6. The load supporting apparatus of claim 5, wherein said means for securing said rigid member comprises a nut screwed on the threads of said bolt.

7. A load supporting apparatus for transporting materials comprising:
a. a substantially horizontal base having a center;
b. a plurality of substantially hollow upright members, each having a length, a first end, and a second end, wherein the first end of each substantially hollow upright member is affixed to said substantially horizontal base and the second end of each substantially hollow upright member has a convex upper surface thereby defining a long side and a short side of said substantially hollow upright member, and wherein the short side of each substantially hollow upright member is oriented toward the center of said base;
c. an elongate aperture in the long side of each substantially hollow upright member, wherein the longitudinal axis of each elongate aperture is substantially perpendicular to said substantially horizontal base;
d. a first hole extending through each substantially hollow upright member between the long side and the short side of said substantially hollow upright member;
e. a second hole extending through each substantially hollow upright member between the long side and the short side of said substantially hollow upright member, wherein said first and second holes are aligned;
f. a rigid member disposed through said first and second holes; and
g. means for securing said rigid member within said first and second holes.

8. The load supporting apparatus of claim 7, wherein said rigid member is a bolt having threads.

9. The load supporting apparatus of claim 8, wherein said bolt is constructed of hardened steel.

10. The load supporting apparatus of claim 8, wherein said means for securing said rigid member comprises a nut screwed on the threads of said bolt.

11. A load supporting apparatus for transporting materials comprising:
a. a basket having a base and a plurality of substantially hollow upright corner posts, each corner post having a length, an upper end, and a lower end, wherein the lower end of each corner post is affixed to said base, and the upper end of each corner post has a convex upper surface thereby defining a long side and a short side of such corner post, and wherein the short side of each corner post is oriented toward the inside of said basket and the long side of each corner post is oriented toward the outside of said basket;
b. an elongate vertical aperture in the long side of each corner post;
c. a first hole extending through each corner post between the long side and the short side of said corner post;
d. a second hole extending through each corner post between the long side and the short side of said corner post, wherein said first and second holes are aligned;
e. a rigid member disposed through said first and second holes; and
f. means for securing said rigid member within said first and second holes.

12. The load supporting apparatus of claim 11, wherein said rigid member is a bolt having threads.

13. The load supporting apparatus of claim 12, wherein said bolt is constructed of hardened steel.

14. The load supporting apparatus of claim 13, wherein said means for securing said rigid member comprises a nut screwed on the threads of said bolt.
